(19) United States
(12) Patent Application Publication
(10) Pub. No.: US 2003/0079611 A1
(43) Pub. Date: May 1, 2003

(54) Dosage scaled beverage sweetener utensil

(76) Inventors: Shannon Panzo, Centennial, CO (US); Lynette F. Taylor, Strathfieldsaye (AU)

Correspondence Address: KYLE W. ROST, 5490 AUTUMN CT., GREENWOOD VILLAGE, CO, 80111, US

(21) Appl. No.: 10/065,548

(22) Filed: Oct. 29, 2002

Related U.S. Application Data
(60) Provisional application No. 60/334,719, filed on Oct. 30, 2001.

(51) Int. Cl. A23L 1/00

(52) U.S. Cl. 99/275

(57) ABSTRACT

A water-soluble dosing and mixing utensil is formed of a cooked mixture of raw cane sugar and glucose, forming a crystal structure with interstitial point defects that toughen the utensil structure. A first end is an immersion portion configured with a width substantially greater than thickness. The opposite end is a handle portion, unitary with the first end. The quantity of material forming the utensil is limited to provide an equivalent sweetness to a dose of refined sugar on the order of two teaspoons (10 ml) or less. The interstitial point defects enable the utensil to have a useful structural integrity despite containing a small volume of forming material. Packaging the utensil in an atmosphere of reduced oxygen content prolongs shelf life and protects from shipping damage.

### CROSS REFERENCE TO RELATED APPLICATIONS

This application claims the benefit of U.S. Provisional Patent Application serial No. 60/334719 filed Oct. 30, 2001, pending.

### BACKGROUND OF INVENTION

1. Field of the Invention

The invention generally relates to foods and beverages. More specifically, it relates to means to treat food, especially by infusion. In another aspect, the invention generally relates to a special receptacle or package, and especially to a package used for infusion. In a further aspect, the invention generally relates to dispensing. More specifically, the invention relates to a method and apparatus for producing a dispensing package. In a further aspect, the invention generally relates to food and to a chemically defined infusion material.

2. Description of Related Art Including Information Disclosed Under 37 CFR 1.97 and 1.98

This invention results from a convergence of two independent needs in the art of food dispensing and packaging. The first is a long-standing need and desire to dispense and mix condiments in an efficient, waste-free manner. The second is a product of recent social or political problems that have resulted in various criminal events in which biologic agents such as anthrax have been spread to unsuspecting citizens through the mails. Both have impact upon the availability and methods of using white, granulated sugar, which frequently is dispensed as a loose powder or in small packets. This invention addresses both the efficiency of mixing and dispensing an equivalent sweetener product and the security of dispensing the sweetener with reduced opportunity for adulteration.

On the first point, the desire for efficient dispensing and mixing, especially of sugar and like sweeteners, has led to development of sugar-coated sticks and straws, plastic holders for sugar cubes and sticks, and various other mostly plastic dispensers for a varying dose of sugar. These items remain novelties of little use, likely because of their high cost and needless complexity in comparison to the ease of opening a paper packet of sugar or adding a teaspoon of sugar from a common bowl. A possible exception is the sugar cube, which has seen modest success. However, the sugar cube merely provides a measured dose and offers no advantage in mixing the sugar dose into a beverage. Instead, a stirrer or teaspoon must be used to stir the cube into the beverage, reducing the cube's benefit of being a pre-measured dose. The sugar-containing sticks, straws, and other dispensing devices of prior art can be distinguished from a sugar cube because they combine dosing with mixing.

Wooden sticks, straws, and plastic holders also have been a necessity in prior doser-mixer combinations because sugar lacks strength or toughness. Crystallized sugar is brittle and easily shatters under load. Because a typical useful dose of sugar is a relatively small amount, i.e., a teaspoon or cube of refined, granular, white sugar, it has not been possible to form a functional, sufficiently durable mixer composed of just this small amount of sugar. While a stout candy cane, lollipop, or sugar stick could serve as an adequate mixer, it would be far from efficient because it would have to contain a vastly excessive amount of sugar or filler materials to acquire the necessary bulk to overcome the inherent brittleness of the sugar crystal. Thus, there has been no suitable answer to the problem of supplying an efficient doser-mixer of sugar.

On the second point, in several known instances a dangerous biologic agent of white, powdered appearance has been spread to the civilian population, and fears remain that such activity may recur. These events suggest that many ordinary practices in the food trades could be similarly abused. Food servers, food consumers, and the public in general wish to eliminate ready sources of such a hazard. In order to promote public safety, security, and confidence, it would be desirable to protect against the introduction of dangerous substances that resemble food or can be hidden within it. For this reason, public airlines have reduced the availability of powdery substances such as sugar, artificial sweetener and powered creamer from airline food service. Other retail food outlets, including both fast food outlets and conventional restaurants, might be expected to follow the airlines' example.

Replacing unit packages of condiments with another source presents a substantial problem. Providing a sugar dispenser at each table appears to solve nothing, since at least the individual dispenser would be open to tampering. Therefore, it would be desirable to supply food accessories and condiments in a way that minimizes ready contamination.

From the perspective of public safety, it would be especially desirable to supply sugar in a pre-measured dose that is more tamper-proof than a sugar packet or cube. From the perspective of efficient dispensing and mixing, it would be desirable to supply sugar in a self-defined mixer configuration.

Patent art shows many attempts to produce a sugar doser-mixer and also shows that such attempts have met with little success. For example, U.S. Pat. No. 3,469,997 to Rossi et al. describes one aspect of the problem. In reviewing past efforts, Rossi notes that granular sugar has been formed into stirrers such as all-sugar spoon shapes, but when used to stir a liquid, these fall apart before they can dissolve. Rossi proposes a particular mix of cane sugars in needle crystal form that can be pressed into a more durable block on a wooden rod handle and individually packaged. This solution may resist an early falling apart in liquids, but a pressed block of sugar remains easy to break and subject to quick degeneration during commercial processing, shipping, and handling. Further, an interface between two dissimilar materials, such as between a sugar block and a wooden rod, inherently is a likely point of failure or breakage, producing still more loose grains. Most seriously, the granular structure of sugar can be tampered with by introducing a white, granular adulterant, whether before or after packaging, since an end-user cannot distinguish one type of white grain from another, and even a sealed package is expected to contain loose, abraded grains without causing any alarm. Finally, it may be inferred on the basis that wooden rods add cost and difficulty to forming the product, that the wooden rods are necessary as a strong core to ensure the strength and integrity of the sugar block.

Numerous other patents show mixers and dispensers whose sole purpose is to provide a novel means of supplying refined sugar in powder, stick, or cube form. The sugar is held on the exterior of a plastic carrier rod, such as in U.S. Pat. No. 6,399,126 to Weldon, Jr. or U.S. Pat. No. 5,866,185 to Burkett; or the sugar is delivered from inside a perforated plastic straw, tube, or mechanical holder in U.S. Pat. No. 5,440,976 to Giuliano et al. or U.S. Pat. No. 4,849,231 to Spee. None of these devices provide protection from a white powdered adulterant that might be applied to the sugar stick, cube, or reservoir. In each, the mechanical carrier is a significant structural component that appears essential to carry or support the sugar.

Candy canes, candy sticks, and lollipops may omit a stick or carrier, but they are unable to be formed as an efficient doser-mixer with sufficient strength to overcome the inherent brittleness of a sugar crystal. As a representative example, U.S. Pat. No. 6,345,977 to Chan shows an all-candy lollipop in which the typical paper stick has been replaced by a stout candy stick, which clearly requires considerable mass and stoutness to carry the lollipop head. The inherent brittleness of sugar crystals is a likely limiting factor on how small or thin an all-candy stick can be.

From the described art, it is evident that a tamper-resistant sugar dosing device or system is not yet known, that can protect the end-user against adulteration via white, powdered adulterants. Therefore, the present invention provides a dosing, stirring, and dispensing means that readily reveals adulteration by white powders.

To achieve the foregoing and other objects and in accordance with the purpose of the present invention, as embodied and broadly described herein, the method and apparatus of this invention may comprise the following.

### SUMMARY OF INVENTION

Against the described background, it is therefore a general object of the invention is to supply condiments and accessories in a form offering improved resistance to tampering.

Specifically, an object of the invention is to supply formerly powdered condiments in a cast, molded, condensed, extruded, glazed, or gelled form.

More specifically, the object of the invention is to supply sweetening substances in commonly accepted dosage quantities, and in the form of a specially contoured, cooked-and-formed utensil. The utensil and its packaging have a uniform appearance such that any tampering can be observed. The sweetener content of a single unit of such candy approximates a desirable consumer dosage, such as the equivalent sweetness of one cube, one teaspoon or less of processed white granulated sugar.

According to the invention, a dosage-scaled beverage sweetener utensil is formed of an immersion portion and a handle portion. The immersion portion is configured to have width substantially greater than thickness, thereby defining a broad and thin shaped first end. The handle portion is connected to the immersion portion and forms a unitary structure with it. Both the immersion portion and handle portion are formed of a pre-selected quantity of cooked-and-formed raw cane sugar containing interstitial point defects, which toughen the utensil structure and enable structural integrity in the broad and thin shape of the immersion portion.

In order to provide adequate speed of dissolution, the immersion portion has a ratio of width to thickness in the range from about 4:1 to 20:1. The rate of dissolution also is influenced by the ratio of surface area to volume, which is preferred to be in the range from 15-30 sq. in. per cubic inch. These thickness ratios and volume-to-area ratios may be carried forward to the handle portion, as well, by employing a handle of equal thickness to the immersion portion. The handle portion may be of an equal width to the immersion portion or as narrow as one-half the width of the immersion portion.

The invention provides a utensil of tough crystal structure by forming the immersion portion and handle portion of a high percentage of raw cane sugar, such as 70% by weight. Raw cane sugar constitutes a sufficient portion of the utensil to provide a sweetness equivalent to a commonly desired dosage of refined sugar, such as no more than two teaspoons (10 ml) of refined, granulated sugar. The sweetness equivalent also may be of one teaspoon (5 ml) of refined, granulated sugar.

According to another aspect of the invention, a dosage-scaled beverage sweetener utensil is formed in a process of, first, cooking raw cane sugar to form a homogeneous mass; second, shaping the mass into a product stream; third, dividing the product stream into sub-units of pre-selected size; fourth, forming a sub-unit into a sweetener utensil; and fifth, packaging the sweetener utensil in an atmosphere of reduced oxygen content.

The product stream is divided into sub-units of pre-selected size by forming the product stream into sub-units of no more than two teaspoons (10 ml) in volume. A sub-unit is formed into a sweetener utensil by forming an immersion end and a handle end, wherein the handle end is of equal thickness as the immersion end. Packaging preferably is accomplished in a contained atmosphere of nitrogen.

The accompanying drawings, which are incorporated in and form a part of the specification, illustrate preferred embodiments of the present invention, and together with the description, serve to explain the principles of the invention. In the drawings:

### BRIEF DESCRIPTION OF DRAWINGS

FIG. 1 is schematic diagram of a manufacturing method and production line for producing the dosing-mixing utensils of the invention.

FIG. 2 is an isometric view of a dosing-mixing utensil.

FIG. 3 is an isometric view of another embodiment of a dosing-mixing utensil.

FIG. 4 is an isometric view of a package for a dosing-mixing utensil.

### DETAILED DESCRIPTION

In one aspect, the invention is a doser-mixer formed of the material to be dispensed, in the approximate volume of an accepted commercial dose, such as the equivalent of one teaspoon or less or white, granulated sugar. A manufactured utensil containing a substantial proportion of raw cane sugar is suitably shaped to be used as a hand-held physical mixer or stirrer; and, due to particular components of the crystal structure, the utensil is given adequate strength and toughness for the intended usage, despite the small quantity of available material, as limited by constraints of dosage size. By physically turning the utensil in a direction of agitation, the user can control both the amount of agitation per stroke and the relative melting rate of the dosage.

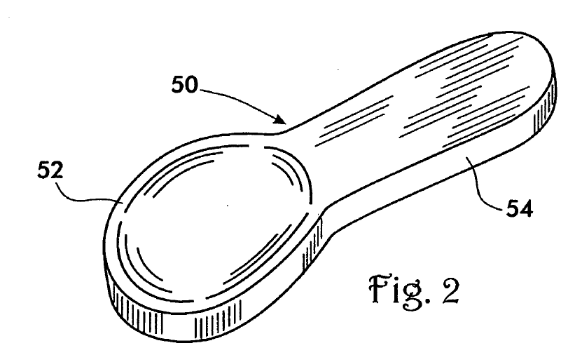

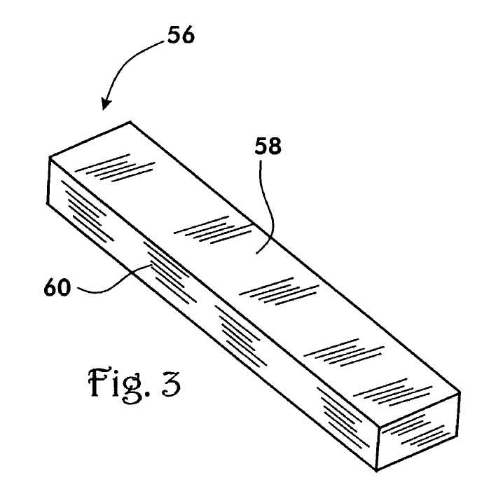

The utensil may be viewed as being formed of two distinct opposite end parts. One end part is an immersion portion that is suited to enter a container of warm or cold beverage, both to stir the beverage and to dissolve itself within the beverage. The second part is an opposite handle end for engagement by a users hand, initially to stir the beverage and hasten the dissolution process. The handle end may be dissolved in the beverage to any desired degree. For example, as shown in FIGS. 2 and 3, a physical mixer utensil can be formed with the immersion portion in the shape of a spoon or paddle, allowing the mixer to agitate a beverage effectively. The handle end may be significantly smaller, narrower, or shorter than the immersion end so that waste is minimal if the handle is not dissolved into the beverage.

In a related aspect, the mixer utensil is formulated of an edible sweetener material and can be rapidly dissolved in a consumable liquid. The effective shape of the immersion portion of the mixer utensil serves the additional two functions of blending the sweeter with the beverage and accelerating the speed of dissolution into the beverage. A related method of operation is to stir a beverage in need of sweetening with the mixer, simultaneously dissolving the mixer into the beverage to sweeten the beverage, and agitating the beverage to blend the sweeter uniformly into the beverage.

Where commercial sweeteners sometimes are supplied in a prepackaged dose of sugar, accompanied by a wooden stick, the mixer utensil replaces both the sugar or other sweetener and the stir stick. Thus, one aspect of the invention can be termed a combined stir stick and sweetener, which eliminates the need for common plastic or wood stir sticks or any combination of the two.

The preferred configurations of the mixer are shown in FIGS. 2 and 3. According to FIG. 2, the mixer 50 has a broad distal end portion 52 for effective stirring. The distal end resembles the end of a spoon or paddle and is both wide and flat so that it presents a high surface area to volume ratio. A proximal handle portion 54 may be flat but narrower in width than the distal end. The resulting shape provides spoon-like agitation of a liquid. It provides a high surface area for the supplied volume, such that it produces and controls rapid melting and solubility of the sweetener. This configuration allows a user to stir the beverage and encourages the mixer utensil to dissolve completely, leaving no mess or discarded stick.

From the perspective of delivering a dose of known and preselected size, it is desirable to completely dissolve the immersion end, such as spoon-shaped end 52, thereby providing notice to the user that the preselected dosage has been delivered. The immersion end preferably is sized to provide a sweetness dosage equivalent from about one-half teaspoon to one teaspoon (2.5-5 ml) of refined, granulated white sugar. The handle end may be formed of a smaller quantity of sweetener, such as an amount equivalent to one-half teaspoon (2.5 ml) or less of refined, granulated white sugar, offering a supplemental dosage that may cumulatively offer the equivalent of a “heaping teaspoon” of sugar. According to this sizing, a user can obtain the sweetness of an ordinary teaspoon (5 ml) of sugar by dissolving an immersion end of either one or two of the utensils. Supplemental sweetness is gained by dissolving the handle portions, if desired. The handle is notably smaller in volume than the immersion end and is preferred to contain only about one-half the volume or less. While the utensil can be scaled to deliver a larger dose, there is little practical benefit in exceeding the dose of one or two sugar packets or cubes.

In order to achieve a high solubility rate, the mixer 50 is configured with a high width-to-average-thickness ratio, preferably in the range from about 4:1 to as high as about 20:1, and a high surface area at the immersible end. The thickness of the paddle or spoon shaped end 52 is preferred to be no greater than 0.125 inches (3.2 mm) and preferably on the order of 0.06 inches (1.5 mm) to enable such complete dissolution at a conveniently sized dosage. The width of the spoon shaped end may be about 0.75-1.0 in. (1.9-2.5 cm). The spoon portion may have a length corresponding to an anticipated immersion length, such as from about 1-2 in (2.5-5 cm). Thus, in a typical spoon-shaped end 52, each fluid ounce of solidified sugar is exposed for dissolution by a surface area from about 25-65 sq. in., or each cubic inch of sugar is exposed for dissolution by a surface area of approximately 15-30 sq. in (6-13 sq. cm/ml.). The thickness of the handle end is preferred to be the same as the immersion end for efficiency of manufacture.

The indicated proportions provide acceptable dissolution rates in hot or cold water for a cooked-and-formed sugar product. In a typical example, the mixing utensil is used to sweeten a cup of hot coffee or tea. The user desires his beverage to be flavored to his liking within a reasonable but short time, such as one to two minutes, which is similar to the time allowed for a tea bag to flavor hot water. Thus, the user likely will consider it reasonable for his beverage to be sweetened within such a time frame.

FIG. 3 shows another embodiment of a mixer or stir stick 56. This stir stick is elongated and is approximately rectangular in transverse cross section. Wide, flat surfaces 58 define opposite front and rear faces, while narrow surfaces 60 define opposite side surfaces. The preferred material of formation, a mixture of raw cane sugar and glucose, is about half as sweet per unit of volume as refined, white, granulated sugar. Thus, a first benefit of using raw cane sugar is an increase in available volume of material for forming the mixer. The stir stick 56 may contain about 8 gm. of the raw cane sugar based mixture, which corresponds in sweetness to about one teaspoon or 4 gm. of refined, white, granulated sugar. The preferred dimensions of stir stick 56 are 10 cm. in length, 1 cm. in width, and 0.2 cm. in thickness. Doubling either the width of thickness provides a ready method of increasing the overall dose available to the equivalent of two teaspoons of refined sugar, or of increasing the dose available from the immersible end to a one full teaspoon.

The rectangular embodiment of FIG. 3 offers a simplified shape in which the handle portion is identical to the immersible portion, and each may be regarded as constituting one half the length of the stirrer 56. Either end can be used as the handle portion or as the immersible portion. Both the handle end and immersion end may contain equal volumes of sweetener, enabling a user to readily double the dosage by dissolving the handle. Thus, this embodiment is well suited to offer a half dose, a single dose, or a double dose, such as the equivalent of from one-half teaspoon to two teaspoons (2.5-10 ml) of refined sugar, within a single utensil. This embodiment is slightly less costly to produce than the spoon or paddle of FIG. 2, because it requires less sophisticated shaping. In addition, it provides the user with an easy understanding of how much sweetener is gained by dissolving the entire utensil instead of only one end.

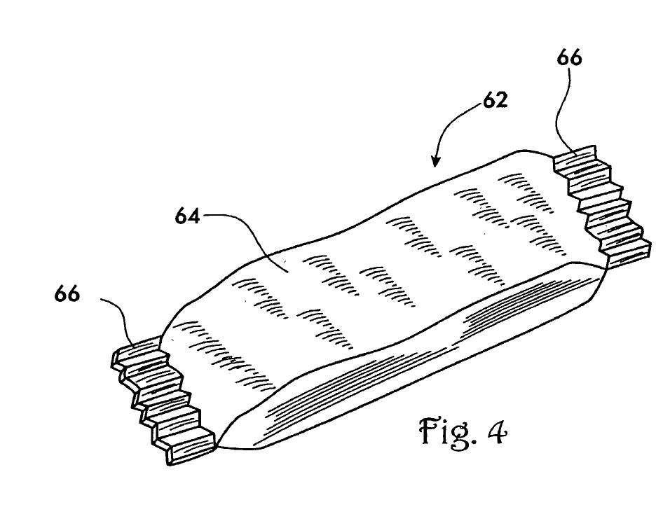

The mixer utensil is packaged in a tamper resistant package 62, FIG. 4. The preferred package consists of airtight metalized plastic tube 64, sealed at both ends by suitable closing structure 66. A package of this type can be produced with flow-through wrapping technology. The packaging tube contains the mixer utensil and a gas under sufficient pressure to give the packaged a full appearance. Nitrogen gas is suitable for filling the package and provides the following advantages:

1. Prevents the oxidation and degradation of the mixer utensil to increase shelf life.

2. Provides a cushion of gas to decrease breakage and maintain integrity of the package contents.

3. May provide an aural signal of pressure release when the package is opened. Such a small sound nevertheless is a confirmation that the unit has not been tampered with.

Other gases can provide these advantages, provided oxygen is absent or at a reduced level relative to atmospheric level, so that oxidation is reduced or eliminated.

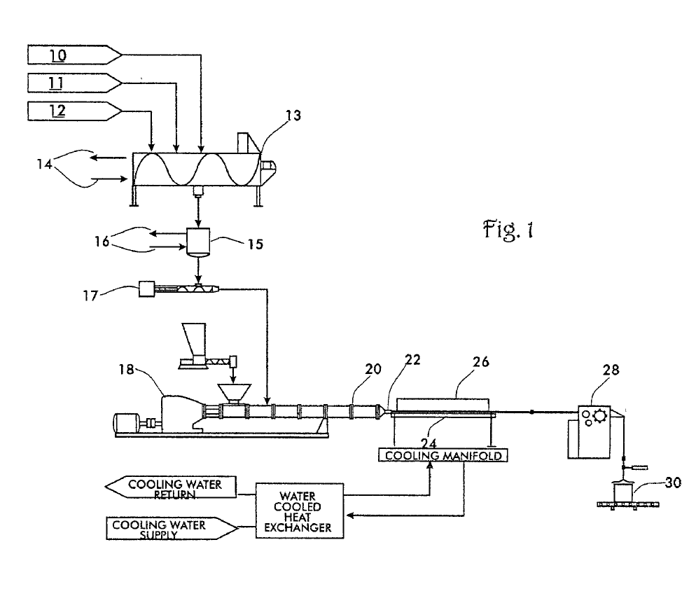

A novel formula and manufacturing process are used to produce the mixer utensils by batch or continuous methods. FIG. 1 shows sources of selected ingredients, which include raw cane sugar 10, glucose 11, and optionally color and flavor 12. An approximate preferred formula of these ingredients in weight percent is 70% raw cane sugar; 30% glucose, also known as confectioners glucose; and optionally, less than 1% of flavor or color approved for use by the U.S. Food and Drug Administration (FDA). These sources 10,11,12 may be sacks, hoppers, conveyed supplies, or the like. The ingredients are added together into a ribbon blender 13, which may be supplied with heating media from sources 14 of conventional nature. The blender produces a homogeneous mixture. From the blender, the mixture enters a surge tank 15, where it may be further heated from conventional media sources 16. A pump 17 receives the mixture from the surge tank and delivers it to an extruder 18 serviced by purger 19. In the extruder, the mixture is cooked. The temperature is raised sufficiently to meet sterilization requirements of the FDA for human consumption. This processing produces a product output stream of uniform sweetener mass having plastic properties.

As the mixture is processed through the extruder, it follows a processing pathway. Optionally, color or flavoring can be introduced at a suitable point 20 in the processing pathway. The plastic mass is extruded from an outlet at the conclusion of the processing pathway within the extruder. A guillotine and roller assembly 22 at the outlet receives the product stream extrusion and suitably divides and shapes the extrusion into sub-units of a pre-selected size, shape and weight. A continuous conveyor belt 24 may be located at the outlet to receive the extruded product sub-units from the guillotine and roller assembly.

The conveyor belt 24 carries the extruded product sub-units through a cooling tunnel 26. The cooling tunnel uses recirculated, refrigerated nitrogen or air to cool the sub-units. At the conclusion of the cooling tunnel 26, a series of cutters and rollers 28 perform the final shaping and produce the mixer utensil products. Next, quality assurance can be conducted on the products.

After quality assurance, the mixer utensil products are sent through a packaging apparatus 30. Packaging uses flow-through wrapping within a nitrogen environment. The individually wrapped products will be conveyed to containers for shipping.

The mixer utensil is formed from a substantial proportion, such as 70%, of raw cane sugar in order to utilize naturally present impurities of raw cane sugar to strengthen the crystal structure of the mixer utensil and enable it to be both thin and tough. The entire utensil is formed from approximately one or two doses of sweetener, representing the equivalent of one or two teaspoons of refined, granulated, white sugar. With the limitation of using this amount of sugar, it is important to improve the toughness and reduce the brittleness of the normal sugar crystal structure. The raw cane sugar enables the mixer utensil to be configured with a high ratio of width to thickness while limiting breakage or other damage at a low level. In addition, the raw cane sugar enables the handle end to be no thicker than the immersion end and often to be substantially narrower than the immersion end. Thus, the use of raw cane sugar or an equivalent source of toughening agents enables the handle to be both thin and tough, so that the stirrer can withstand shipping, handling, and usage without the failure problems found in prior utensils formed of refined sugar.

Raw cane sugars contain natural protein strands and organic impurities. When the raw cane sugar is cooked to form a homogeneous liquid or plastic mass, these natural impurities become distributed throughout the mass. As the mass is cooled in the shape of the final product, the impurities comprise interstitial point defects within the newly formed crystalline structure. These point defects produce a tougher structure, as compared to a similar product formed exclusively of refined sugar from which these natural impurities have been removed. The uniform distribution of the natural impurities throughout the whole device gives the device uniform surface tension, which decreases breakage. Thus, a thin and wide sugar product has sufficient strength and toughness to be formed, packaged, shipped, and eventually employed as a stirrer that is suited to dissolve rapidly in a warm beverage such as coffee or tea or cold beverage such as iced tea.

The use of cooked and formed sugar has the additional advantage that the product is clear or translucent, rather than the opaque white color of granular sugar. A clear product offers reduced opportunities for subsequent adulteration by a granular or powdered white adulterant. The cooking process may sterilize against any adulterant or other similar biologic agent that entered the raw materials prior to cooking. A subsequently added white powder is easily noticed. Due to the product toughness enabled by the interstitial point defects from raw cane sugar, the utensil has low susceptibility to breakage and it is not substantially affected by minor abrasions.

The cooking and extruding process results in the product having a glossy or semi-glossy surface. The glossiness of the surface makes the utensil resistant to permeation by air and oxygen. This contributes to the product being resistant to oxidation, graining off, or the introduction of contaminants; and it extends shelf life. Graining-off might generate powdered debris in a similar device composed of pressed, refined, granular sugars. The cooked-and-formed product is highly stable and characterized by a long shelf life.

The forgoing is considered as illustrative only of the principles of the invention. Further, since numerous modifications and changes will readily occur to those skilled in the art, it is not desired to limit the invention to the exact construction and operation shown and described, and accordingly all suitable modifications and equivalents may be regarded as falling within the scope of the invention.

1. A dosage-scaled beverage sweetener utensil, comprising:
an immersion portion configured to have width substantially greater than thickness, thereby defining a broad and thin shaped first end;
a handle portion forming a second end and connected to said immersion portion, forming a unitary structure therewith; and
wherein said immersion portion and handle portion are formed of a pre-selected quantity of cooked-and-formed raw cane sugar containing interstitial point defects toughening the utensil structure and enabling structural integrity in the broad and thin shape of said immersion portion.

2. The beverage sweetener utensil of claim 1, wherein said immersion portion has a ratio of width to thickness in the range from 4:1 to 20:1.

3. The beverage sweetener utensil of claim 1, wherein said immersion portion is configured such that the ratio of surface area to volume is in the range from 15-30 sq. in. per cubic inch.

4. The beverage sweetener utensil of claim 1, wherein said immersion portion and handle portion are of substantially equal thickness.

5. The beverage sweetener utensil of claim 1, wherein said handle portion is of a width no less than one-half the width of said immersion portion.

6. The beverage sweetener utensil of claim 1, wherein said immersion portion and handle portion consist of approximately 70% by weight raw cane sugar.

7. The beverage sweetener utensil of claim 1, wherein said pre-selected quantity of raw cane sugar is a quantity sufficient to provide sweetness equivalent to no more than two teaspoons (10 ml) of refined, granulated sugar.

8. The beverage sweetener utensil of claim 1, wherein said pre-selected quantity of raw cane sugar is a quantity sufficient to provide sweetness equivalent to no more than one teaspoon (5 ml) of refined, granulated sugar.

9. A method of forming a dosage-scaled beverage sweetener utensil, comprising:
first, cooking raw cane sugar to form a homogeneous mass;
second, shaping said mass into a product stream;
third, dividing the product stream into sub-units of pre-selected size;
fourth, forming a sub-unit into a sweetener utensil; and
fifth, packaging the sweetener utensil in an atmosphere of reduced oxygen content.

10. The method of claim 9, wherein said step of dividing the product stream into sub-units of pre-selected size comprises:
forming the product stream into sub-units containing a quantity of raw cane sugar equivalent in sweetness to refined sugar of no more than two teaspoons (10 ml) in volume.

11. The method of claim 9, wherein said step of forming a sub-unit into a sweetener utensil comprises:
forming an immersion end and a handle end, wherein the handle end is no more than one-half the width of the immersion end, and the immersion end and handle end are of equal thickness.

12. The method of claim 9, wherein said packaging step comprises:
packaging the sweetener utensil in a contained atmosphere of reduced oxygen content relative to atmosphere.
